(19) United States
(12) Patent Application Publication
(10) Pub. No.: US 2003/0216983 A1
(43) Pub. Date: Nov. 20, 2003

(54) Method and architecture for online receipts

(75) Inventor: William Kress Bodin, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/150,113

(22) Filed: May 16, 2002

(51) Int. Cl. G06F 17/60

(52) U.S. Cl. 705/35

(57) ABSTRACT

A method, program, and system for consolidating and routing electronic receipt data are provided. The invention comprises receiving identification data from a user and authenticating the user's identity. Electronic receipt data is then retrieved from a point of sale terminal within a computer network and routed to a repository, wherein the repository is associated with the user. In one embodiment, the receipt data is converted into Receipt Markup Language (RML), which is a DTD of XML. In another embodiment, the receipt data is routed to a plurality of destinations, according to user preferences.

### BACKGROUND OF THE INVENTION

1. Technical Field

The present invention relates generally to computer network environments, and more specifically to consolidation and storage of data in reference to user identification.

2. Description of Related Art

Current business processes for Point of Sale (POS) generate a “hard-copy receipt” or “electronic receipt” for the customer for every purchase. This POS process also keeps receipts for the customers, merchants, and credit card companies (assuming the purchase was made with a credit card). Thus, the same receipt information is kept in multiple locations. However, customers may have trouble keeping track of and organizing their receipts.

Therefore, it would be desirable to have an electronic receipt service that enables customers to retrieve their electronic receipts and control the disposition of those receipts.

### SUMMARY OF THE INVENTION

The present invention provides a method, program, and system for consolidating and routing electronic receipt data. The invention comprises receiving identification data from a user and authenticating the user's identity. Electronic receipt data is then retrieved from a point of sale terminal within a computer network and routed to a repository, wherein the repository is associated with the user. In one embodiment, the receipt data is converted into Receipt Markup Language (RML), which is a DTD of XML. In another embodiment, the receipt data is routed to a plurality of destinations, according to user preferences.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4A depicts a diagram of a client in the form of a personal digital assistant (PDA) in accordance with a preferred embodiment of the present invention;

FIG. 4B depicts a block diagram illustrating the hardware configuration of a PDA in accordance with a preferred embodiment of the present invention;

FIG. 5 depicts a flowchart illustrating a method for consolidating and routing electronic receipts in accordance with the present invention;

FIG. 6 depicts a diagram illustrating the architecture for accessing the user repository in accordance with the present invention; and

FIG. 7 depicts a schematic diagram illustrating the architecture of the electronic receipt service in accordance with the present invention.

### DETAILED DESCRIPTION OF THE PREFERRED EMBODIMENT

The present invention provides a consolidated data store for electronic receipts and establishes and assimilates user identification for seamless routing of receipt-type data.

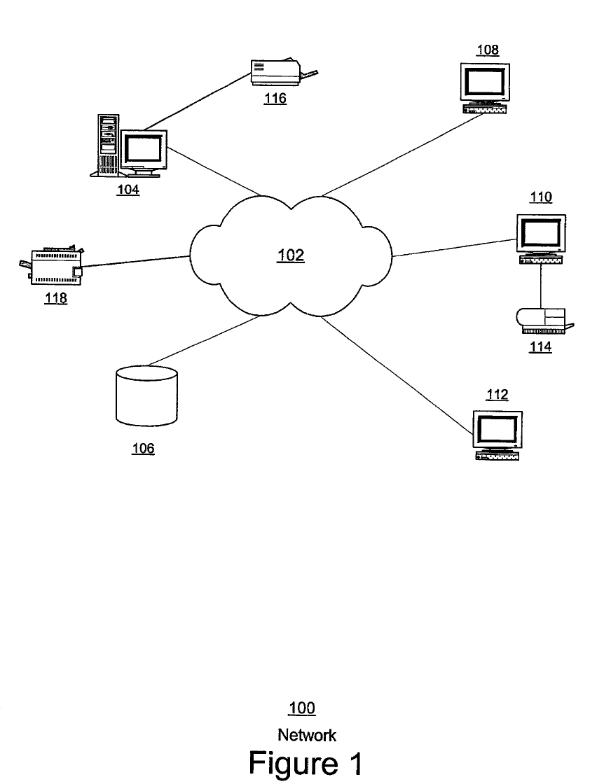

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

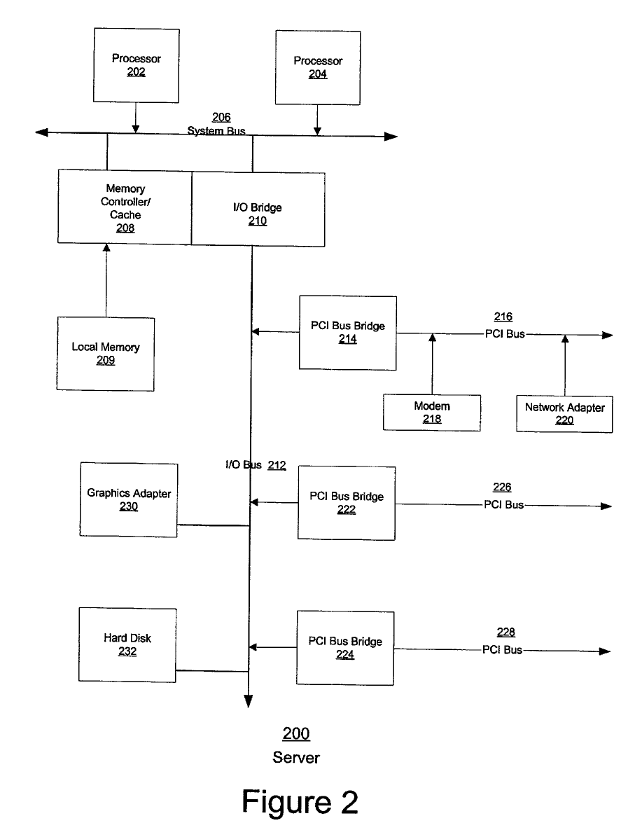

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

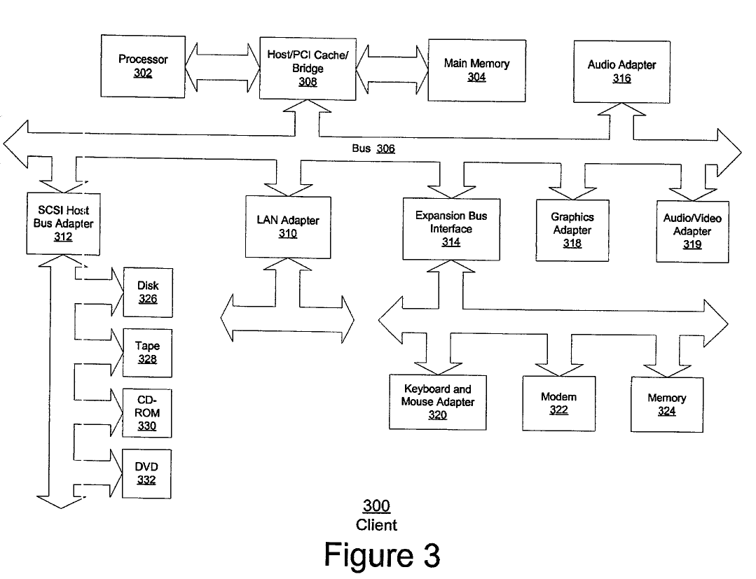

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, CD-ROM drive 330, and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

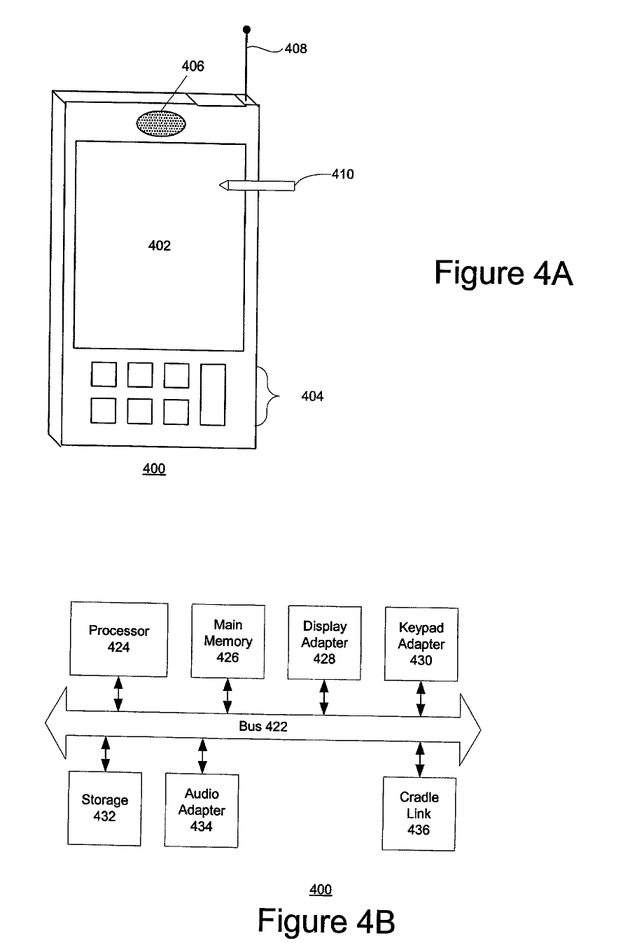

With reference now to FIG. 4A, a diagram of a client in the form of a personal digital assistant (PDA) is depicted in accordance with a preferred embodiment of the present invention. PDA 400 includes a display 402 for presenting textual and graphical information. Display 402 may be a known display device, such as a liquid crystal display (LCD) device. The display may be used to present a map or directions, calendar information, a telephone directory, or an electronic mail message. In these examples, screen 402 may receive user input using an input device such as, for example, stylus 410.

PDA 400 may also include keypad 404, speaker 406, and antenna 408. Keypad 404 may be used to receive user input in addition to using screen 402. Speaker 406 provides a mechanism for audio output, such as presentation of an audio file. Antenna 408 provides a mechanism used in establishing a wireless communications link between PDA 400 and a network, such as network 100 in FIG. 1.

PDA 400 might rely on Wireless Application Protocol (WAP) for facilitating communications. WAP is a standard for providing PDA's, wireless phones, pagers and other handheld devices with secure access to e-mail and text-based Web pages. WAP provides a complete environment for wireless applications that includes a wireless counterpart of TCP/IP and a framework for telephony integration such as call control and phone book access. WAP features the Wireless Markup Language (WML), which was derived from Phone.com's HDML and is a streamlined version of HTML for small screen displays. It also uses WMLScript, a compact JavaScript-like language that runs in limited memory. WAP also supports handheld input methods such as a keypad and voice recognition. Independent of the air interface, WAP runs over all the major wireless networks in place. WAP is also device independent, requiring only a minimum functionality in the unit so that it can be used with a myriad of phones and handheld devices.

PDA 400 also preferably includes a graphical user interface that may be implemented by means of systems software residing in computer readable media in operation within PDA 400.

Turning now to FIG. 4B, a block diagram illustrating the hardware configuration of PDA 400 is shown in accordance with a preferred embodiment of the present invention. PDA 400 is an example of a PDA in which code or instructions implementing the processes of the present invention may be located. PDA 400 includes a bus 422 to which processor 424 and main memory 426 are connected. Display adapter 428, keypad adapter 430, storage 432, and audio adapter 434 also are connected to bus 422. Cradle link 436 provides a mechanism to connect PDA 400 to a cradle used in synchronizing data in PDA 400 with another data processing system. Further, display adapter 428 also includes a mechanism to receive user input from a stylus when a touch screen display is employed.

An operating system runs on processor 424 and is used to coordinate and provide control of various components within PDA 400 in FIG. 4B. The operating system may be, for example, a commercially available operating system such as Windows CE, which is available from Microsoft Corporation. Instructions for the operating system and applications or programs are located on storage devices, such as storage 432, and may be loaded into main memory 426 for execution by processor 424.

Those of ordinary skill in the art will appreciate that the hardware in FIG. 4B may vary depending on the implementation. Other internal hardware or peripheral devices, such as flash ROM (or equivalent nonvolatile memory) or optical disk drives and the like, may be used in addition to or in place of the hardware depicted in FIG. 4B.

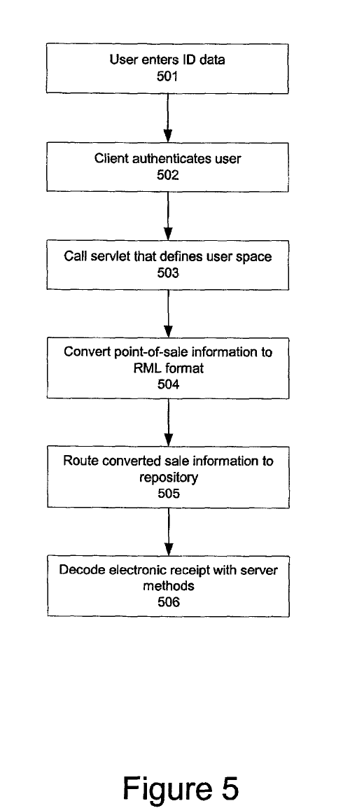

Referring to FIG. 5, a flowchart illustrating a method for consolidating and routing electronic receipts is depicted in accordance with the present invention. During a transaction, user identification data is entered into a point of sale (POS) client machine (i.e. register) (step 501). The client machine then authenticates the user ID (step 502). This may include any form of pervasive-device-based authentication, such as personal identification number (PIN), passwords, userID, biometrics, radio frequency identification (RFID), or any other authentication method known in the art. Though the authentication process occurs at the client, it is done with real time access to servers which hold preferences and personal identification information.

The authentication request from the POS client to the server calls a servlet, which then accesses the user's space (portlet) within the server to which electronic receipts are to be routed and stored (step 503).

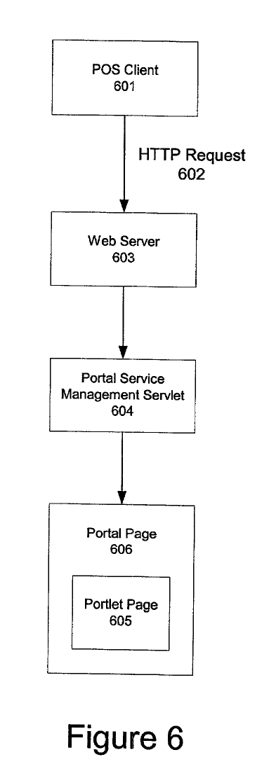

Referring to FIG. 6, a diagram illustrating the architecture for accessing the user repository is depicted in accordance with the present invention. The POS client 601 sends a HyperText Transfer Protocol (HTTP) request 602 to the Web application server 603.

The server 603 calls a portal service management servlet 604 to access the defined user space. Servlets are Java applications that run on a server and provide server-side processing for client request. A common use for servlets is providing dynamic content, e.g., returning the results of a database query. In the present invention, the servlet provides the server-side processing for access to the user database and communication with the POS client machine. Since servlets are written in Java, they are portable between servers and operating systems, allowing communication between servers and clients with different operating systems.

The portal service management servlet 604 accesses the portlet page 605 which defines the user's space on the server. The servlet 604 receives all incoming HTTP requests and dispatches each request to the appropriate destination URL. As a result, all access to the portlet pages 605 is controlled by the servlet 604. From the point-of-view of the servlet 604, the portlet page 605 is a content component implemented as a Java Service Page (JSP). This portlet JSP 605 defines the static and dynamic content for a specific content subject within a portal page 606 that provides access to Web content. In the present invention, the content defined by the portlet page 605 includes the user's electronic receipt repository. The portlet page 605 generates dynamic XML content from the server 603 to the POS client 601 by accessing data entities or content adapters.

Communication between the POS client 601 and server 603 is via eXtensible Markup Language (XML), which improves the functionality of the Web by providing more flexible and adaptable information identification. XML is similar to HyperText Markup Language (HTML), but whereas HTML defines how elements are to be displayed, XML defines what the elements contain.

The authentication of the user ID also notifies the server 603 as to where the transaction is taking place. This location information may include the particular store and even the specific POS machine 601 handling the transaction, depending on the level of granularity desired by the customer.

Referring again to FIG. 5, following the authentication process, the electronic receipt originating at a POS terminal may be converted to Receipt Markup Language (RML) format, which is a receipt-specific Document Type Definition (DTD) of XML (step 504). A DTD is a formal description written in XML Declaration Syntax of a particular type of document. The DTD sets out what names are to be used for the different types of elements, where they may occur in the document, and how they fit together. In the present invention, RML is a formal description of an electronic receipt.

This receipt information is routed to a repository (portlet space) that has been specified as the holding area on behalf of the customer (step 505). The receipt is then decoded and stored by server methods applied by the servlet (step 506).

The receipt information may be shadowed at any number of other persistent data stores or server instances, which may or may not be based at or affiliated with the receipt originating enterprise. The preferences associated with a particular user may also specify a plethora of additional routings which can occur as part of the process, for example, e-mail accounts or Wireless Application Protocol (WAP) sites.

The electronic receipt repository may take the form of an account with a service provider, similar to an e-mail account. The repository may also be on a personal computer with a persistent Internet connection, such as a cable connection. For example, in response to the authentication inquiry from the POS client, the server may return a Uniform Resource Locator (URL) address to which the electronic receipt is to be sent. Electronic receipts may also be sent directly to the user's pervasive computing device, e.g., cell phone, PDA, pager, laptop computer, etc. The user can then download the receipts from the pervasive device to a permanent repository, such as those described above.

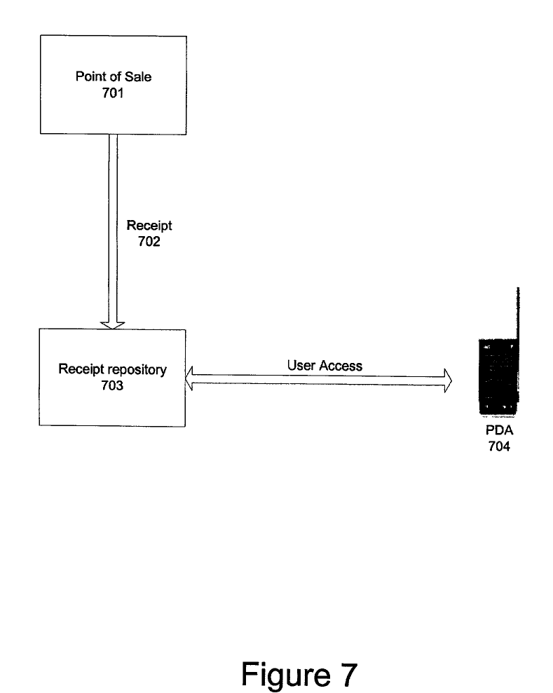

Referring to FIG. 7, a schematic diagram illustrating the architecture of the electronic receipt service is depicted in accordance with the present invention. The electronic receipt 702 is generated in RML format at the POS client 701 and then stored in the receipt repository 703. After the electronic receipt 702 has been decoded and stored, the customer may access the receipts by means of a pervasive computing device, e.g., PDA 704.

If necessary, the server may upload an applet to the PDA 704 when the user accesses the receipt repository 703. In this case, the servlet on the server and the applet on the PDA 704 can communicate using XML or RML.

Intelligent data mining can be applied to the electronic receipt repository. For example, electronic receipts may be used to check for product upgrades, to maintain product service schedules, and to purchase extended warranties. Electronic receipts may also be used for applying discounts or providing proof of purchase to merchants. Storing these receipts in a personal repository simplifies the process of organizing and accessing these receipts, rather than having to organize and keep track of multiple paper receipts and carry them when visiting merchants in order to take advantage of special offers. In addition, accessing electronic receipts by means of a pervasive computing device provides convenience to users who want to access the receipts while shopping.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
receiving user identification data at a point of sale client within a computer network;
authenticating the user identification data;
sending the point of sale client an address for a repository associated with the user identity; and
routing electronic receipt data sent from the point of sale client to the repository.

2. The method according to claim 1, wherein authentication of the user identification data is by means of user data and preferences stored on a network server.

3. The method according to claim 1, wherein the step of authenticating the user identification data further comprises calling a servlet that can communicate with the point of sale client by means of XML and receipt markup language.

4. The method according to claim 1, wherein the electronic receipt data is formatted in receipt markup language.

5. The method according to claim 1, further comprising:
duplicating the receipt data; and
routing the duplicate on at least one of a plurality of destinations.

6. The method according to claim 5, wherein the routing destinations are specified by user preferences.

7. The method according to claim 1, wherein the repository is on a server.

8. The method according to claim 1, wherein the repository is on a second client within the computer network, and wherein the second client has a persistent connection to the network.

9. The method according to claim 1, wherein the repository is on a pervasive computing device.

10. The method according to claim 1, further comprising:
receiving a request from a pervasive computing device to access electronic receipt data in the repository, wherein the request includes user identification data associated with the repository;
sending the requested electronic receipt data to the pervasive computing device.

11. The method according to claim 10, further comprising uploading an applet to the pervasive computing device, wherein the applet communicates with the repository by means of XML and receipt markup language.

12. A computer program product in a computer readable medium for use in a data processing system, the computer program product comprising:
first instructions for receiving user identification data at a point of sale client within a computer network;
second instructions for authenticating the user identification data;
third instructions for sending the point of sale client an address for a repository associated with the user identity; and
fourth instructions for routing electronic receipt data sent from the point of sale client to the repository.

13. The computer program product according to claim 12, wherein authentication of the user identification data is by means of user data and preferences stored on a network server.

14. The computer program product according to claim 12, wherein the second instructions further comprise a servlet that can communicate with the point of sale client by means of XML and receipt markup language.

15. The computer program product according to claim 12, wherein the electronic receipt data is formatted in receipt markup language.

16. The computer program product according to claim 12, further comprising:
fifth instructions for duplicating the receipt data; and
sixth instructions for routing the duplicate on at least one of a plurality of destinations.

17. The computer program product according to claim 16, wherein the routing destinations are specified by user preferences.

18. The computer program product according to claim 12, further comprising:
seventh instructions for receiving a request from a pervasive computing device to access electronic receipt data in the repository, wherein the request includes user identification data associated with the repository;
eight instructions for sending the requested electronic receipt data to the pervasive computing device.

19. The computer program product according to claim 18, further comprising:
ninth instructions for uploading an applet to the pervasive computing device, wherein the applet communicates with the repository by means of XML and receipt markup language.

20. A method comprising:
a receiving component for receiving user identification data at a point of sale client within a computer network;
an authentication component for authenticating the user identification data;
a communication component for sending the point of sale client an address for a repository associated with the user identity; and
a routing component for routing electronic receipt data sent from the point of sale client to the repository.
